(19) United States
(12) Patent Application Publication
(10) Pub. No.: US 2009/0119704 A1
(43) Pub. Date: May 7, 2009

(54) METHOD AND APPARATUS TO CATCH UP WITH A RUNNING BROADCAST OR STORED CONTENT

(75) Inventors: Nevenka DIMITROVA, Pelham Manor, NY (US); Mauro BARBIERI, Eindhoven (NL); Lalitha AGNIHOTRI, Tarrytown, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/568,122

(22) PCT Filed: Apr. 21, 2005
(86) PCT No.: PCT/IB05/51318

§ 371 Date: Oct. 20, 2006

Related U.S. Application Data
(60) Provisional application No. 60/564,775, filed on Apr. 23, 2004.

(51) Int. Cl. H04N 5/445; H04N 5/44

(52) U.S. Cl. 725/38; 348/734; 348/E05.096

(57) ABSTRACT

A portion 301-303 of a content stream 300 for a program is automatically summarized using a summarization function mapping the program to a new segment space and depending upon whether the content portion is a beginning, intermediate, or ending portion of the content stream 300. The summary generated also depends on the duration of the summarized segment, the selected length of the summary, program type (live broadcast or replay from storage), genre, and personalized user profile information. A full summary of the entire program, if available, may be employed in generating the content portion summary. Automatic video content analysis, together with analysis of subtitles or ancillary information sources, if either is available, may be employed to generate the summary.

The present invention relates generally to playing streams of content and, more particularly, to providing automatic and customized summarization of content streams.

On occasion, viewers of entertainment content streams such as found in television broadcasts or on digital versatile disks (DVDs) may desire to “catch up” with developments within the stream's content after missing a portion, but without viewing the entire missed portion. In these circumstances, some summary generated using automatic content analysis and summarization methods would be beneficial.

There is, therefore, a need in the art for an effective approach to automatic summarization of a portion of a running broadcast or stored content.

To address the above-discussed deficiencies of the prior art, it is a primary object of the present invention to provide, for use in a content presentation system, automatic summarization of a portion of a content stream for a program using a summarization function mapping the program to a new segment space and depending upon whether the content portion is a beginning, intermediate, or ending portion of the content stream. The summary generated also depends on the duration of the summarized segment, the selected length of the summary, program type (live broadcast or replay from storage), genre, and personalized user profile information. A full summary of the entire program, if available, may be employed in generating the content portion summary. Automatic video content analysis, together with analysis of subtitles or ancillary information sources, if either is available, may be employed to generate the summary. Other technical advantages will be readily apparent to one skilled in the art from the following figures, description, and claims.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

For a more complete understanding of the present invention, and the advantages thereof, reference is now made to the following descriptions taken in conjunction with the accompanying drawings, wherein like numbers designate like objects, and in which:

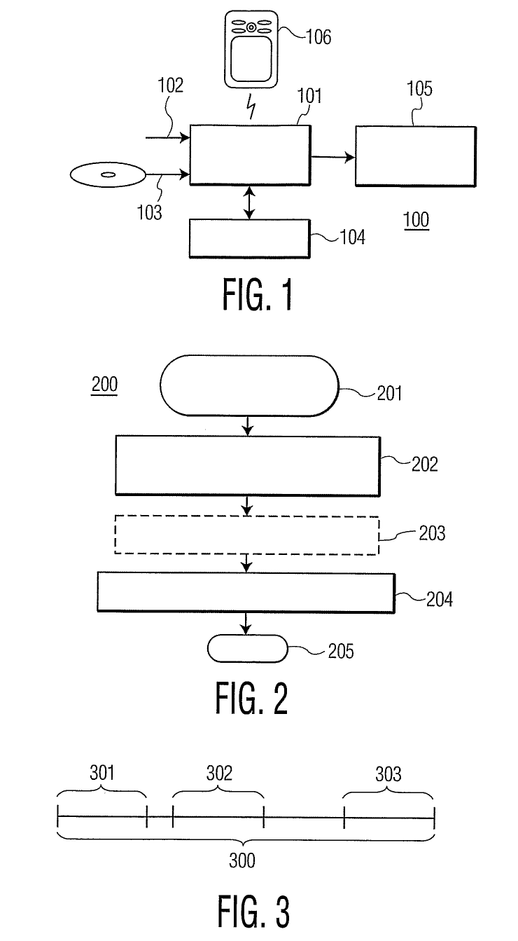

FIG. 1 depicts a combined content presentation and automatic summarization system according to one embodiment of the present invention;

FIG. 2 is a high-level flow chart illustrating a process of summarizing a portion of a program according to one embodiment of the present invention; and

FIG. 3 illustrates different portions of a program subject to automatic summarization according to one embodiment of the present invention.

FIGS. 1 through 3, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged device.

FIG. 1 depicts a combined content presentation and automatic summarization system according to one embodiment of the present invention. System 100 includes a processor or controller 101 having a connection 102 to one or more of a broadcast, terrestrial or satellite antenna, broadcast cable, or the Internet over which video and/or audio content is received. Alternatively, or in addition to connection 102, system 100 includes a connection 103 for retrieving stored content from storage media, such as a digital versatile disk (DVD), compact disk (CD), Secure Digital (SD) memory, or the like. Processor 101 is also connected to storage 104 containing software executable by processor 101 to control operation of the system 100 and to generate play of the content received on connection(s) 102 and/or 103 on the output device(s) 105 (e.g., a video display and/or audio speakers), and to perform automatic summarization as described in further detail below. System 100 may optionally include a remote control device 106, preferably programmable, providing a set of user controls for operating system 100 and optionally implementing a portion of the summarization process. For example, remote control device 106 may include a dedicated button for initiating automatic summarization of a missed portion of the content.

Those skilled in the art will recognize that the complete construction and operation of a content presentation and automatic summarization system 100 is not depicted in the drawings or described herein. Instead, for simplicity or clarity, only so much of a content presentation and automatic summarization system as is necessary for an understanding of the invention or unique to the invention is depicted and described. In addition, those skilled in the art will recognize that content presentation and automatic summarization system 100 may be implemented, for example, as one or more of a television system, a video or audio receiver, a video or audio player, a combination of any of those devices, a personal digital assistant (PDA), etc.

For the purposes of illustration only, summarization according to the present invention will be described with reference to video content from terrestrial or broadcast video content streams or recorded on video storage media. Currently, the electronic program guide (EPG) for broadcast video content provides a brief description of a running program, along with high-level information such as title, genre, cast, etc. In addition, summarization techniques allow a shorter representation of video content to be generated, typically for an entire program. A problem addressed by the present invention relates to joining a program already in progress and catching up with events within the missed portion of the program, or quickly getting a summary of an arbitrary portion of a movie or other program. For example, if a viewer starts watching a baseball game 30 minutes after that game commenced, the summarization system should give the best highlights for the game so far.

The present invention provides intelligent, adaptive summarization techniques that give the best summarization outcome by taking into account the total program length (if known), the elapsed program length, genre, and full generic summary (if available). The catch-up summary generated based on that information should be personalized for the individual viewer.

FIG. 2 is a high-level flow chart illustrating a process of summarizing a portion of a program according to one embodiment of the present invention. Process 200 is performed by processor 101 by executing a software program from storage 104, operating on content received on input(s) 102 and/or 103. Process 200 begins with summarization of a portion of the received content (or program) being initiated (step 201). First, a generic summarization function S(p) for the program p is derived (step 202) that maps the continuous original program into a new segment space based on the presence or absence of certain features within the content. For programs for which a full summary F(p) is available, the full summary is retrieved (optional step 203). A catch-up summary C(p) for a missed portion (identified based on when the user joins a program in progress or by user definition) is derived using the summarization function S(p) operating on the program portion, as well as the full summary F(p) if available, based on parameters in the user profile for length of desired summary, media elements (images, audio, text) to be included in the summary, content elements in the summary, etc. In the simplest case, the catch-up summary C(p) may be a linear function picking only certain elements from both summaries S(p) and F(p), as described in further detail below.

The goal of the present invention is to summarize just a portion of program to catch-up with a movie or any running program or scheduled broadcast. System 100 is presumed to have a recordation capability for storage of program content and metadata information in storage 104, coupled with software executing on processor 101 for analysis of program content. Although generic summarization techniques are known, summarization of just a portion of a program requires solution to the problem of automatically summarizing missed content when part of the program in progress has already been presented and a viewer wishes to join in at the current point of the program, without watching the entire missed portion.

FIG. 3 illustrates different portions of a program subject to automatic summarization according to one embodiment of the present invention. In the present invention, the summary generated depends on whether a beginning, middle or ending portion of a running program is to be summarized. In a quick start scenario, the viewer wants to begin viewing a program n minutes after the program has started. In a break in the middle scenario, the viewers attention is temporarily averted to another task such as a telephone call and, rather than watching the entire missed portion, the user may want to simply “catch-up” with what happened during her absence in less time than she was actually absent. Such a feature is useful for sports broadcasts where a user does not wish to delay an entire remainder of the broadcast, but prefers to learn what happened (e.g., what interesting events occurred) and then rejoin the program in progress at the current temporal point. Finally, in a fast finish scenario, toward the end of a program the user may wish to do something else (e.g., go out) rather than watching all of the remainder of the program, but does not wish to miss the ending.

The present invention provides a “catch-up” summary of a portion of a running program 300 based on whether the portion summarized is a beginning, intermediate, or ending portion 301-303, respectively, of the program. This means that a normal summarization algorithm will be “biased” based on the beginning and end of the summarized portion relative to the real length of the program, such that an adaptive summarizer taking into account not only the features, but also iterates several times over the summarization to determine the final summary. The summary should also be personalized based on user preference, such as available time, missed time, preferences for textual, spatial or multimedia summary, genre, and location where the summary is watched.

In addition, the summarization will differ depending on whether the program is stored and pre-analyzed or whether the program involves broadcast of live content. In the case of a live broadcast, a decision must be made regarding the content to be summarized based on what is known so far in the program, regardless of what is important later on. In summarizing stored content (either on storage media or broadcast from storage), where the full program is available, the summarization of a beginning or intermediate portion may be biased based on important turns of events later. For example, if a person initially appears as a minor character but later becomes a key figure, more information in the summary regarding that character may be included in the summary for beginning and intermediate portions 301, 302 of the program 300 than warranted solely by the content of those portions.

For stored content, consideration should be given to the source of the content to the summarization process: DVD, broadcast, or Web downloaded movie. In the case of a DVD or similar storage media, the catch-up summary may include the preview trailer or other information included on the storage media. In addition, the summarization system can selectively focus on a particular event or person. If filmographies are included on the storage media, the summarization algorithm may employ those as well.

In the case of downloaded movies, additional information from other Web sites may be provided to the summarization algorithm, such as the full transcript or story board providing information about the plot and the story ending even if subtitle data is not available for the stored video. Movie reviews from critics and fans may be employed to cross-check important events and characters within the movie. Using this information requires detailed semantic textual and linking with the audio-visual analysis, through subtitles for example. If no sophisticated analysis is possible then the reviews may be used at least to enrich the summary by giving an additional point of view.

For either stored or downloaded content, if an Internet connection is available, or external information from another source, the summarization process may be influenced by information available from those sources. For example, a Web site on World War II may be employed to add new information to a World War II movie.

Summary completeness and summary presentation are two factors for consideration in generating the summary. The necessity of using the full summary and influence of the full summary on the partial summary are considerations for summary completeness, as is whether the “fast finish” option is being employed. Different modes for summary presentation to the user may be based on how the user wants the summary, and upon the available summary time, the missed time, user preferences, genre, to provide, for instance, one of an instant summary, a quick overview, or a complete (long) summary.

Strictly by way of example, summarization of a movie according to the present invention may proceed as follows: For a quick start summary (summarizing the beginning portion of the movie), the summary includes the trailer (if available), the title page, the title cast from the electronic program guide, and mapping of the movie content under time constraint maximization (i.e., 15 minutes maps to 2 minutes, and 45 minutes also maps to 2 minutes). For a middle or intermediate portion summary, novelty items are presented, with selection of summary content personalized, summary content is included based on person detection and event detection (e.g., explosions), appearance of new characters, and depending on the ending (if available). For a fast finish summarization of the ending, the summary provides the viewer with information about the plot culmination (e.g., the identity of the killer or whether the central characters get married), what happens to each significant character, a complete summary of events and resolution of any enigmas within the movie (for a “slow” fast finish), and the epilogue paragraph of text if present.

In the present invention, a special button or programmable user control on the remote control 106 is preferably provided to give the user access to the catch-up functionality. The catch-up summary is presented instantly based on the user preferences. The type of summary generated (beginning, middle or end) may be automatically selected based on whether the program has been presented since the start, joined in progress, etc., or based upon user input. By actuating the catch-up button different numbers of times in succession, the used can select the level of summary presentation (i.e., the amount of detail or duration). The same interface can be employed for all three catch-up summaries: beginning, middle and end. In the case of the ending, the user can actuated the control and then go out, expecting that the device will behave according to the user's preferences as to when the catch-up summary should be delivered-that it, the summary of the ending of the movie may be waiting on the home movie server when the viewer returns, or the viewer may expect a telephone call from the home media server that contains a description of the ending.

The present invention allows automatic summarization of an arbitrary content stream portion for a user, with the summarization differing depending on whether the portion summarized is the beginning of the content stream, an intermediate segment, or the end of the content stream, using a summarization function that maps the program content into a new segment space. The summary generated depends also on the duration of the summarized segment, the selected length of the summary, program type (live broadcast or replay from storage), genre, and personalized user profile information. A full summary of the entire program, if available, may be employed in generating the partial summary, and the summarization process may be iterated to derive the final summary. Automatic video content analysis, together with analysis of subtitles or ancillary information sources, if either are available, may be employed to generate the summary.

It is important to note that while the present invention has been described in the context of a fully functional system, those skilled in the art will appreciate that at least portions of the mechanism of the present invention are capable of being distributed in the form of a machine usable medium containing instructions in a variety of forms, and that the present invention applies equally regardless of the particular type of signal bearing medium utilized to actually carry out the distribution. Examples of machine usable mediums include: nonvolatile, hard-coded type mediums such as read only memories (ROMs) or erasable, electrically programmable read only memories (EEPROMs), recordable type mediums such as floppy disks, hard disk drives and compact disc read only memories (CD-ROMs) or digital versatile discs (DVDs), and transmission type mediums such as digital and analog communication links and frames or packets.

Although the present invention has been described in detail, those skilled in the art will understand that various changes, substitutions, variations, enhancements, nuances, gradations, lesser forms, alterations, revisions, improvements and knock-offs of the invention disclosed herein may be made without departing from the spirit and scope of the invention in its broadest form.

1. A content presentation system [100], comprising:
an input [102, 103] at which a content stream is received;
storage [104] in which at least a portion of the received content stream is stored; and
a controller [101] coupled to the storage [104] and summarizing a selected portion of the received content stream, wherein a summary generated by the controller [101] depends upon whether the selected portion of the received content stream is a beginning, intermediate, or ending [301-303] portion of the content stream [300].

2. The content presentation system [100] according to claim 1, wherein the summary generated by the controller [101] depends upon a length of the selected portion of the content stream [300] and a summary length.

3. The content presentation system [100] according to claim 1, wherein the summary generated by the controller [101] depends upon an elapsed time of the content stream [300] and a total length of the content stream [300].

4. The content presentation system [100] according to claim 1, wherein the summary generated by the controller [101] depends upon whether the content stream [300] comprises a live broadcast or replay of stored content.

5. The content presentation system [100] according to claim 1, wherein the controller [101] executes a summarization function mapping the selected portion of the content stream [300] to a new segment space to generate the summary.

6. The content presentation system [100] according to claim 5, wherein the summarization function employs a full summary for the entire content stream [300], if available.

7. The content presentation system [100] according to claim 5, wherein the summarization function includes one or more of video content analysis, subtitle analysis, and analysis of ancillary information retrieved from a source separate from the content stream [300].

8. A video display device including the content presentation system [100] according to claim 1, the video display device comprising:
a display [105] on which the content stream [300] and the summary are presented; and
a remote control unit [10] selectively controlling operation of the video display device.

9. The video display device according to claim 8, wherein the remote control unit [106] includes a user control for selectively initiating generation of the summary by the controller [101].

10. A content presentation method [200], comprising:
receiving a content stream [300];
storing at least a portion of the received content stream [300]; and
summarizing a selected portion of the received content stream [300], wherein a summary generated by the sumarization depends upon whether the selected portion of the received content stream [300] is a beginning, intermediate, or ending portion of the content stream [300].

11. The method [200] according to claim 10, wherein the summary depends upon a length of the selected portion of the content stream [300] and a summary length.

12. The method [200] according to claim 10, wherein the summary depends upon an elapsed time of the content stream [300] and a total length of the content stream [300].

13. The method [200] according to claim 10, wherein the summary depends upon whether the content stream [300] comprises a live broadcast or reply of stored content.

14. The method [200] according to claim 10, wherein the summary is generated by execution of a summarization function mapping the selected portion of the content stream [300] to a new segment space.

15. The method [200] according to claim 14, wherein the summarization function employs a full summary for the entire content stream [300], if available.

16. The method [200] according to claim 14, wherein the summarization function includes one or more of video content analysis, subtitle analysis, and analysis of ancillary information retrieved from a source separate from the content stream [300].

17. The method [200] according to claim 10, further comprising:
initiating generation of the summary in response to actuation of a user control on a remote control device [106].

18. A video system [100] comprising:
a display [105]; and
a controller [101] selectively initiating display of a summary for a selected portion of a content stream [300] being displayed on the display [105], wherein the summary depends on whether the selected portion is a beginning, intermediate or ending portion of the content stream [300].

19. The video system [100] according to claim 18, wherein the summary depends upon one or more of:
a length of the selected portion of the content stream [300];
a user-selected summary length;
an elapsed time of the content stream [300];
a total length of the content stream [300]; and
whether the content stream [300] comprises a live broadcast or replay of stored content.

20. The video system [100] according to claim 18, wherein the controller initiates display of the summary in response to actuation of a summarization user control on a remote control [106] associated with the video system [100].
